(19) United States
(12) Patent Application Publication
(10) Pub. No.: US 2018/0073808 A1
(43) Pub. Date: Mar. 15, 2018

(54) THERMAL DISTORTION ARRESTOR

(71) Applicant: FORD GLOBAL TECHNOLOGIES, LLC, Dearborn, MI (US)

(72) Inventors: Shunmugam Baskar, West Bloomfield, MI (US); Bruce Richard Ghastin, Canton, MI (US); Christina Dung Nguyen, Northville, MI (US)

(21) Appl. No.: 15/261,186

(22) Filed: Sep. 9, 2016

(51) Int. Cl. F27D 5/00; B60R 13/02; E05C 21/00; B23P 19/00

(52) U.S. Cl. CPC F27D 5/00; B60R 13/0243; F27D 2005/0093; E05C 21/00; B23P 19/00; B60R 13/0206

(57) ABSTRACT

A thermal distortion arrestor includes a body having a base and a plurality of positioning lugs that extend from a first face of the base. A related door assembly and method of installing a thermal distortion arrestor in a door assembly are also disclosed.

### TECHNICAL FIELD

This document relates generally to the thermal processing (i.e. heating and cooling) of automotive closures in E-coat and paint ovens and, more particularly, to a thermal distortion arrestor which minimizes relative movements between panels during thermal processing in order to avoid hem slippage.

### BACKGROUND

Automobile body panels including, particularly, door, hood, deck lid or any automotive closures undergo E-coat and paint oven processing. All parts undergo some degree of thermal expansion and contraction during this thermal process which tends to induce thermal strain potentially leading to distortion of the panels. Further, some parts are bonded through adhesive that has a low adhesive modulus at ambient temperature which will not provide good joint strength, but when cured at a higher temperature in an oven provides a higher adhesive modulus for a stronger joint.

In the ovens, automotive panels and parts need to be well supported to minimize/eliminate movement/slip between panels and parts during heating and cooling and avoid distortion due to thermal expansion.

This document relates to a new and improved thermal distortion arrestor which is effective to minimize movement or slippage between panels and parts undergoing thermal processing. Such a thermal distortion arrestor is effective in avoiding hem slippage between, for example, a door inner panel and a door outer panel. Advantageously, the thermal distortion arrestor disclosed in this document is easy to install and use and represents a significant advance in the art.

### SUMMARY

In accordance with the purposes and benefits described herein, a thermal distortion arrestor is provided. That thermal distortion arrestor comprises a body including a base and a plurality of positioning lugs extending from a first face of the base. The plurality of positioning lugs may include a first lug having a first flange at a first distal end thereof and a second lug having a second flange at a second distal end thereof.

The plurality of positioning lugs may also include a third lug having a third flange at a third distal end thereof and a fourth lug having a fourth flange at a fourth distal end thereof.

The first lug may be aligned with the second lug along a first axis. Additionally, the third lug may be aligned with the fourth lug along a second axis. That first axis may be perpendicular to the second axis.

The first flange may be oriented outward on the first lug. The second flange may be oriented outward on the second lug. The third flange may be oriented outward on the third lug. The fourth flange may be oriented outward on the fourth lug.

The first flange may include a first abutment surface. The second flange may include a second abutment surface. The third flange may include a third abutment surface. The fourth flange may include a fourth abutment surface.

The first abutment surface and the second abutment surface may be oriented within a perimeter of the base. In contrast, the third abutment surface and the fourth abutment surface may be oriented outside the perimeter of the base. The four abutment surfaces may all be oriented toward the base.

In accordance with an additional aspect, a door assembly is provided. That door assembly comprises a door inner panel including an aperture, a door outer panel and a thermal distortion arrestor. The thermal distortion arrestor includes a base secured to the door outer panel and a plurality of positioning lugs nested in the aperture of the door inner panel.

The plurality of positioning lugs may include a first lug having a first abutment surface engaging a first side of the door inner panel and a second lug having a second abutment surface engaging a first side of the door inner panel.

Further, the plurality of positioning lugs may include a third lug having a third abutment surface engaging the first side of the door inner panel and a fourth lug having a fourth abutment surface engaging the first side of the door inner panel.

In addition, the door inner panel may include a margin around the aperture. The first lug may engage a first side edge of the margin while the second lug engages a second side edge of the margin, the third lug engages a third side edge of the margin and the fourth lug engages a fourth side edge of the margin.

In accordance with yet another aspect, a method is provided for installing a thermal distortion arrestor in a door assembly including a door inner panel and a door outer panel. That method comprises the steps of inserting a first end of the thermal distortion arrestor into an aperture in the door inner panel and bonding a base of the thermal distortion arrestor to the door outer panel.

The method may also include the step of nesting a plurality of positioning lugs on the thermal distortion arrestor within the aperture in the door inner panel. Still further, the method may include the step of engaging a margin of the door inner panel around the aperture with a plurality of positioning lugs.

In the following description, there are shown and described several preferred embodiments of the thermal distortion arrestor. As it should be realized, the thermal distortion arrestor is capable of other, different embodiments and its several details are capable of modification in various, obvious aspects all without departing from the thermal distortion arrestor as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the thermal distortion arrestor and together with the description serve to explain certain principles thereof. In the drawing figures:

FIG. 1 is a detailed perspective view of the thermal distortion arrestor.

FIG. 2 is a perspective view illustrating a door assembly wherein the thermal distortion arrestor of FIG. 1 is nested in an aperture in a door inner panel with the base of the arrestor bonded to the door outer panel.

FIG. 3 is a cross-sectional view of the door assembly taken along line 3-3 of FIG. 2.

FIG. 4 is a cross-sectional view of the door assembly taken along line 4-4 of FIG. 2.

FIGS. 5a and 5b are schematic illustrations of the method of installing the thermal distortion arrestor in the door assembly illustrated in FIG. 2.

Reference will now be made in detail to the present preferred embodiments of the thermal distortion arrestor, an example which is illustrated in the accompanying drawing figures.

### DETAILED DESCRIPTION

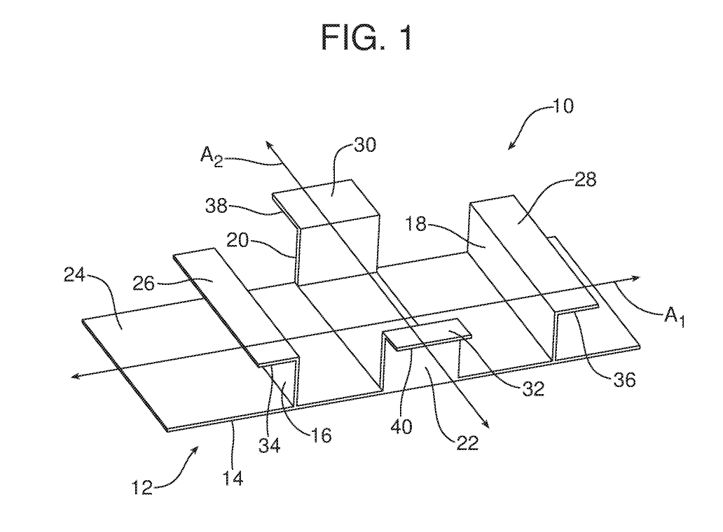

Reference is now made to FIGS. 1-4 illustrating the thermal distortion arrestor 10. The thermal distortion arrestor 10 includes a body, generally designated by reference numeral 12. The body 12 may be made from a metal, a composite or a plastic material. The body 12 may also be flexible. The body 12 includes a base 14 and a plurality of positioning lugs 16, 18, 20, 22 extending from a first face 24 of the base.

The first lug 16 includes a first flange 26 at a first distal end thereof. The first flange 26 is oriented outward on the first lug 16. The second lug 18 includes a second flange 28 at a second distal end thereof. The second flange 28 is oriented outward on the second lug 18. In the illustrated embodiment, the first lug 16 is aligned with the second lug 18 along a first axis A₁.

As further illustrated in FIG. 1, the third lug 20 includes a third flange 30 at a third distal end thereof and the fourth lug 22 includes a fourth flange 32 at a fourth distal end thereof. The third flange 30 is oriented outward on the third lug 20. The fourth flange 32 is oriented outward on the fourth lug 22.

In the illustrated embodiment, the third lug 20 is aligned with the fourth lug 22 along a second axis A₂. In the illustrated the embodiment the first axis A₁ and the second axis A₂ are perpendicular to one another.

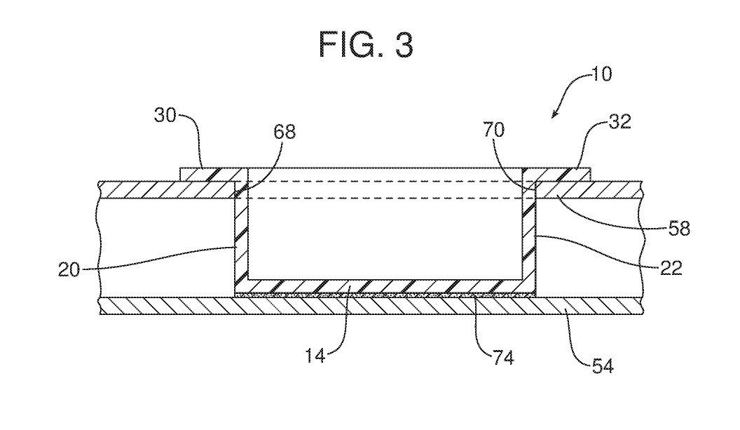

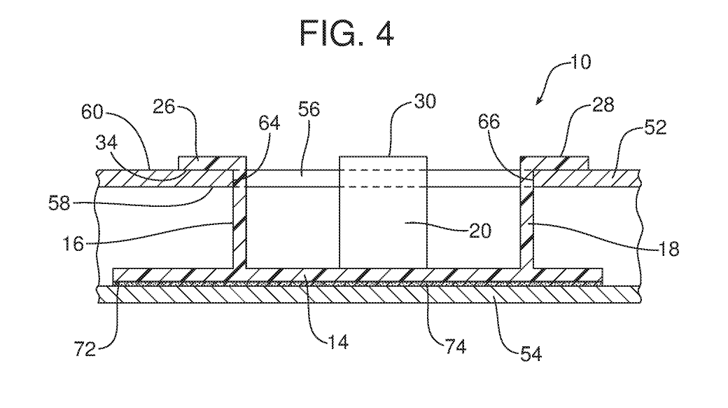

As best illustrated in FIGS. 3 and 4, the first flange 26 includes a first abutment surface 34. The second flange 28 includes a second abutment surface 36. The third flange 30 includes a third abutment surface 38. The fourth flange 32 includes a fourth abutment surface 40. As should be appreciated from reviewing FIGS. 3 and 4, the first and second abutment surfaces 34, 36 are oriented within the perimeter of the base 14. In contrast, the third and fourth abutment surfaces 38, 40 are oriented outside of the perimeter of the base 14.

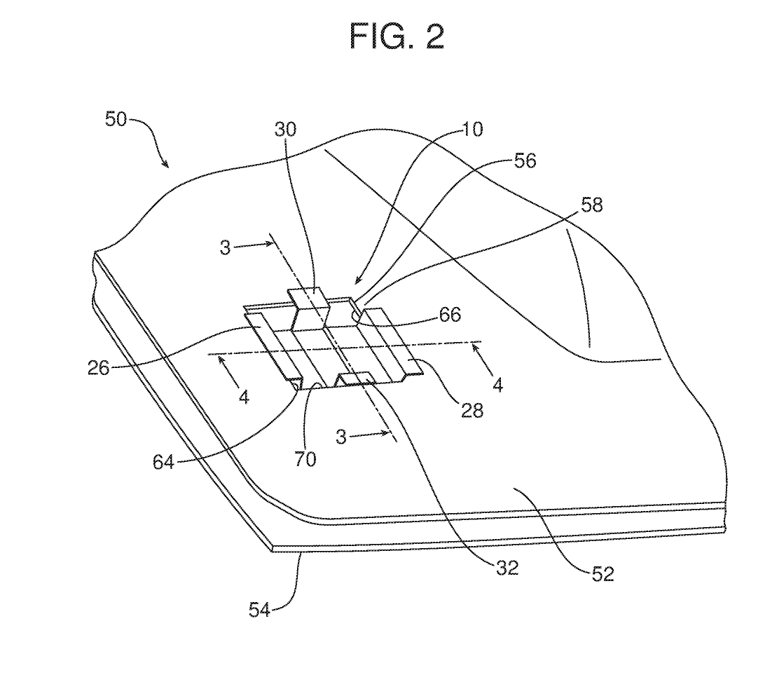

Reference is now made to FIGS. 2-4 illustrating a door assembly 50 which includes the door inner panel 52, the thermal distortion arrestor 10 and a door outer panel 54. As illustrated, the door inner panel 52 includes an aperture 56 outlined by a margin 58 of the door inner panel. As illustrated, the base 14 of the thermal distortion arrestor 10 is secured to the door outer panel 54 by bonding with adhesive 74 or other appropriate means. Further, the plurality of positioning lugs 16, 18, 20, 22 of the thermal distortion arrestor 10 are nested in the aperture 56.

More specifically, the first abutment surface 34 on the first lug 16 engages a first side 60 of the door inner panel 52 at the margin 58. The second abutment surface 36 of the second lug 18 engages the first side 60 of the door inner panel 52 at the margin 58. The third abutment surface 38 on the third lug 20 and the fourth abutment surface 40 on the fourth lug 22 also engage the first side 60 of the door inner panel 52 at the margin 58.

More specifically, the first lug 16 engages a first side edge 64 of the margin 58. The second lug 18 engages a second side edge 66 of the margin 58. The third lug 20 engages a third side edge 68 of the margin 58. The fourth lug 22 engages a fourth side edge 70 of the margin 58.

As should be appreciated, this arrangement of the positioning lug 16, 18, 20, 22 and this engagement of the side edges 64, 66, 68, 70 of the margin 58 when the thermal distortion arrestor 10 is nested and fully seated in the aperture 56 in the door inner panel 52 functions in cooperation with the bonding of the base 14 to the door outer panel 54 to eliminate slippage and relative movement between the door inner panel 52 and the door outer panel 54 as a result of thermal expansion that may be induced in either or both of those components in the E-coat and paint oven. Thus, it should be appreciated that the thermal distortion arrestor 10 functions to resist and eliminate distortion/deflection in the door inner panel 52 and door outer panel 54 thereby maintaining hem integrity.

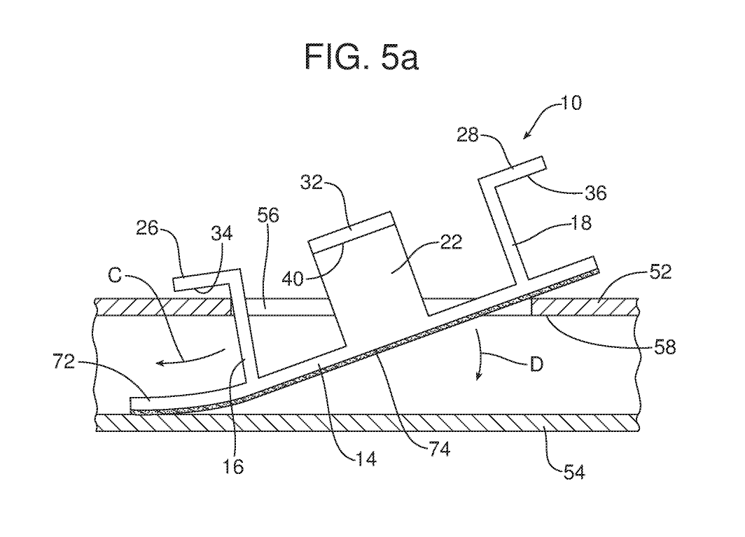

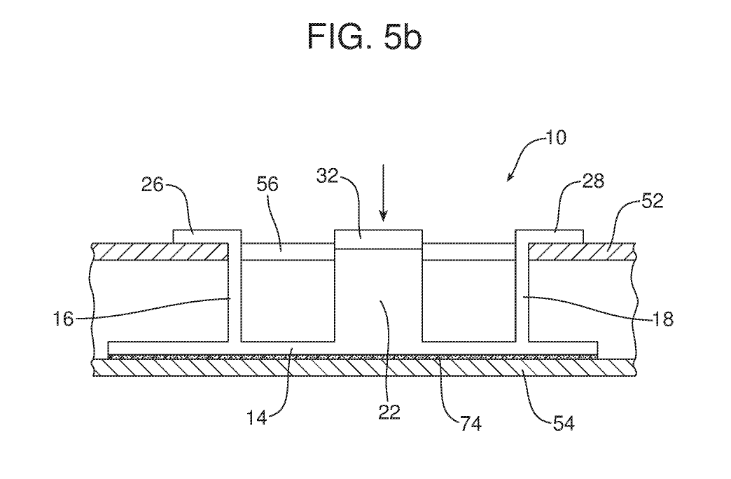

Reference is now made to FIGS. 5a and 5b which illustrate a method of installing the thermal distortion arrestor 10 in the door assembly 50. That method includes inserting a tongue or first end 72 of the base 14 of the thermal distortion arrestor 10 into the aperture 56 in the door inner panel 52 (note action arrow C). This is then followed by pivoting the thermal distortion arrestor 10 in the direction of action arrow D so as to allow bonding of the base 14 of the thermal distortion arrestor to the door outer panel 54. The method includes the nesting of the plurality of the positioning lugs 16, 18, 20, 22 of the thermal distortion arrestor 10 within the aperture 56 in the door inner panel 52 and the engaging of the margin 58 of the door inner panel around the aperture with the abutment surfaces 34, 36, 38, 40 of the positioning lugs 16, 18, 20, 22.

The foregoing has been presented for purposes of illustration and description. It is not intended to be exhaustive or to limit the embodiments to the precise form disclosed. Obvious modifications and variations are possible in light of the above teachings. For example, the illustrated embodiment of the thermal distortion arrestor 10 includes four positioning lugs 16, 18, 20, 22. It should be appreciated that the thermal distortion arrestor 10 could include fewer or more positioning lugs 16, 18, 20, 22 as desired or required by the needs of any particular application.

The door assembly 50 illustrated in FIG. 2 includes only one thermal distortion arrestor 10. It should be appreciated that the door assembly 50 could include more than one thermal distortion arrestor 10 secured in additional apertures 56 provided in the door inner panel 52 again, as needed or required for any particular application in order to control movement or slippage between the panels 52, 54 during thermal processing.

It should also be appreciated that one or more of the positioning lugs 16, 18, 20, 22 or the flanges 26, 28, 30, 32 provided on those positioning lugs may be made to be breakable should they in any way hinder the manufacturing or assembly process after they have completed their function to limit part movement or slippage and distortion during the paint drying process.

All such modifications and variations are within the scope of the appended claims when interpreted in accordance with the breadth to which they are fairly, legally and equitably entitled.

What is claimed:

1. A thermal distortion arrestor, comprising:
a body including a base and a plurality of positioning lugs extending from said base.

2. The thermal distortion arrestor of claim 1, wherein said plurality of positioning lugs include a first lug having a first flange at a first distal end thereof and a second lug having a second flange at a second distal end thereof.

3. The thermal distortion arrestor of claim 2, wherein said plurality of positioning lugs include a third lug having a third flange at a third distal end thereof and a fourth lug having a fourth flange at a fourth distal end thereof.

4. The thermal distortion arrestor of claim 3, wherein said first lug is aligned with said second lug along a first axis.

5. The thermal distortion arrestor of claim 4, wherein said third lug is aligned with said fourth lug along a second axis.

6. The thermal distortion arrestor of claim 5, wherein said first axis is perpendicular to said second axis.

7. The thermal distortion arrestor of claim 6, wherein said first flange is oriented outward on said first lug, said second flange is oriented outward on said second lug, said third flange is oriented outward on said third lug and said fourth flange is oriented outward on said fourth lug.

8. The thermal distortion arrestor of claim 7, wherein said first flange includes a first abutment surface, said second flange includes a second abutment surface, said third flange includes a third abutment surface and said fourth flange includes a fourth abutment surface.

9. The thermal distortion arrestor of claim 8 wherein said first abutment surface and said second abutment surface are oriented within a perimeter of said base.

10. The thermal distortion arrestor of claim 9, wherein said third abutment surface and said fourth abutment surface are oriented outside said perimeter of said base.

11. The thermal distortion arrestor of claim 10, wherein said first abutment surface is oriented toward said base.

12. The thermal distortion arrestor of claim 11, wherein said second abutment surface, said third abutment surface and said fourth abutment surface are oriented toward said base.

13. A door assembly, comprising:
a door inner panel including an aperture;
a door outer panel; and
a thermal distortion arrestor having a base secured to said door outer panel and a plurality of positioning lugs nested in said aperture.

14. The door assembly of claim 13, wherein said plurality of positioning lugs include a first lug having a first abutment surface engaging a first side of said door inner panel and a second lug having a second abutment surface engaging said first side of said door inner panel.

15. The door assembly of claim 14, wherein said plurality of positioning lugs include a third lug having a third abutment surface engaging said first side of said door inner panel and a fourth lug having a fourth abutment surface engaging said first side of said door inner panel.

16. The door assembly of claim 15, wherein door inner panel includes a margin around said aperture, said first lug engages a first side edge of said margin, said second lug engages a second side edge of said margin, said third lug engages a third side edge of said margin and said fourth lug engages a fourth side edge of said margin.

17. A method of installing a thermal distortion arrestor in a door assembly including a door inner panel and a door outer panel, comprising:
inserting a first end of said thermal distortion arrestor into an aperture in said door inner panel; and
bonding a base of said thermal distortion arrestor to said door outer panel.

18. The method of claim 17, including nesting a plurality of positioning lugs of said thermal distortion arrestor within said aperture in said door inner panel.

19. The method of claim 18, including engaging a margin of said door inner panel around said aperture with a plurality of positioning lugs.

20. The method of claim 19 including engaging said margin of said door inner panel along four sides of said aperture.
